(19) United States
(12) Patent Application Publication
(10) Pub. No.: US 2021/0035237 A1
(43) Pub. Date: Feb. 4, 2021

(54) Wanna Hang

(71) Applicant: Giulia GIOVANNELLI, San Piero a Sieve (IT)

(72) Inventor: Giulia GIOVANNELLI, San Piero a Sieve (IT)

(21) Appl. No.: 16/530,841

(22) Filed: Aug. 2, 2019

(51) Int. Cl. G06Q 50/00; G06Q 30/02; G06Q 10/10

(52) U.S. Cl. CPC G06Q 50/01; G06Q 30/0201; G06Q 10/1095; G06Q 30/0261; G06Q 30/0252

(57) ABSTRACT

“Wanna Hang” is a social network that can help create more effective connections between people, through new and interesting tools. It is addressed to both individual users and businesses, that can interact creating/attending events, get real feedbacks and bring out the best relationships. The aim is to focus on direct contact between people rather than virtual relations.

“Wanna Hang” can help people get in touch with more care about social life and real life meetings. It can also help small companies—that usually don't have a large visibility—to get benefits from those connections and find new ways to increase their business opportunities.

### BACKGROUND OF THE INVENTION

I've spent more than 15 years travelling around the world, I realized that the progress in technology and mobile applications helped a lot connecting people and creating networks for improved cooperation, but in spite of this many people find themselves more lonely and isolated. I think that people feel the need to get in touch with people with same interests and passions, to share experiences and ideas. Leaving love affairs and online dating apart, I think that people really want to improve the quality of their REAL life.

### BRIEF DESCRIPTION OF DRAWINGS

FIG. 1. Mobile application: subscribe through email/password or Facebook account.

FIG. 2. Mobile application: login through email/password or Facebook account.

FIG. 3. Mobile application: user profile with personal information, picture, list of feedbacks from other users, and score on the “Wanna Hang” platform.

FIG. 4. Mobile application: list of Likes and Interests in the user profile.

FIG. 5. Mobile application: users can choose a favorite area to receive notifications about new events and social opportunities.

FIG. 6. Mobile application: users can subscribe groups and manage their subscriptions.

FIG. 7. Mobile application: users can create new events on the “Wanna Hang” platform.

FIG. 8. Mobile application: users can browse groups created on the “Wanna Hang” platform.

FIG. 9. Mobile application: user's friend list.

FIG. 10. Mobile application: events created and attended by the users, with photo albums storing the photo taken or tagged during the event itself.

FIG. 11. Mobile application: details of an upcoming event, that the user can join.

FIG. 12. Mobile application: details of a past event, that the user can comment, vote, and fill with photos.

FIG. 13. Allowed actions for “businesses”, “anonymous users” and “registered users”.

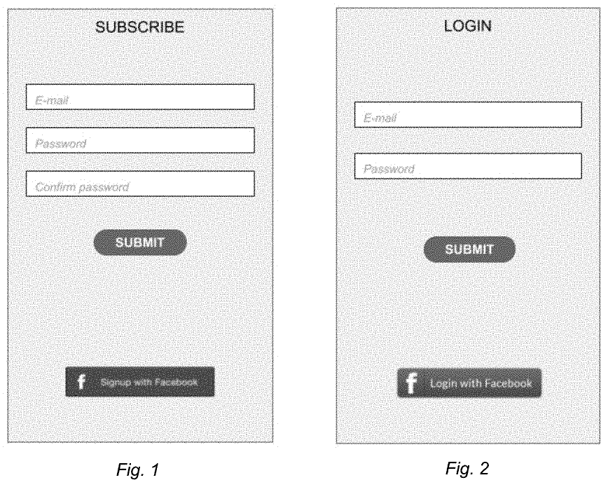

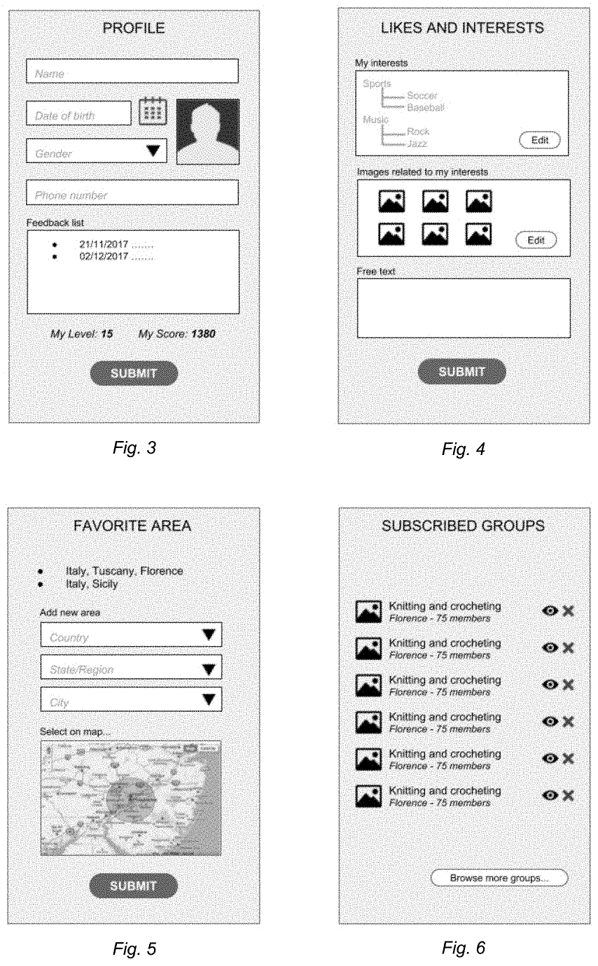

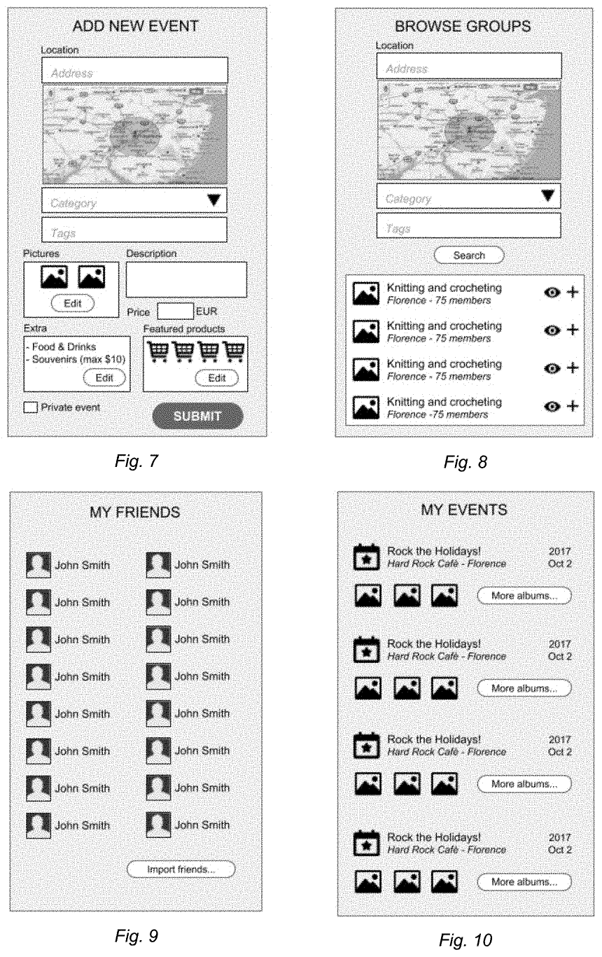

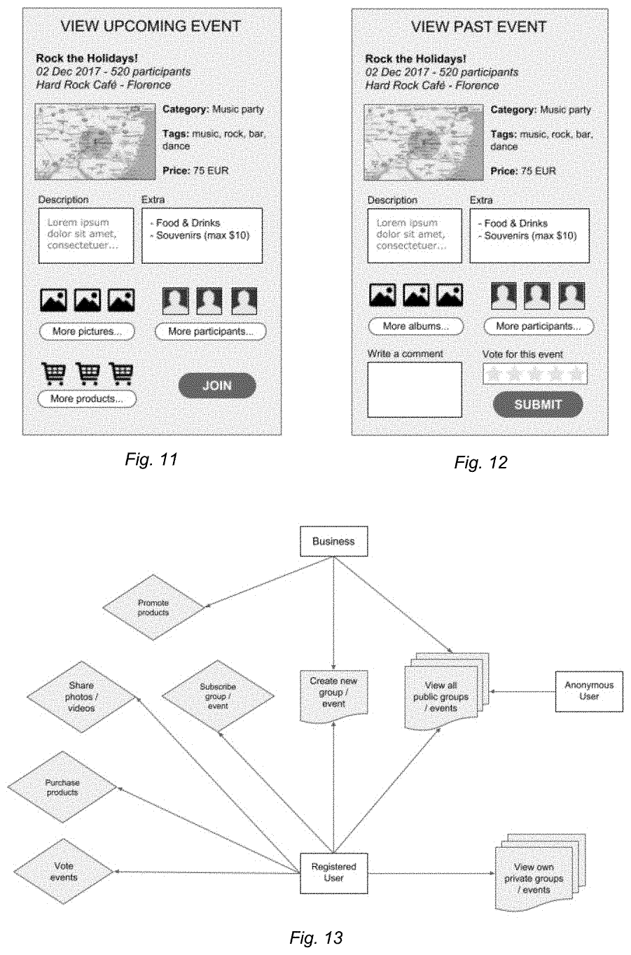

### USE FOR INDIVIDUAL ACCOUNTS

Individual users can download the app and create their own account on “Wanna Hang”, by entering email/password or connecting through their existing Facebook account. The registration is free and allows people to customize their profile with personal information and interests. Personal information may include name, date of birth, gender, phone number, city. First name, age, gender and city could be optionally shared with other users. Individual users can also select their interests from a huge list, that includes categories like Music (playing, dancing, listening, teaching, shows, etc.), Sports (practicing [soccer, baseball, bowling, etc.], relaxing [yoga], etc.) or Arts (exhibitions, architecture, painting, etc.), and so on . . . .

Users are also invited to add their own photo (it should be mandatory, no avatars admitted) and optional comments/pictures about their favorite interests and hobbies. Users will select an area on a map, from a small city to a whole country. They will be connected to the people in the same area, and will be able to browse for groups and events sharing a common interest.

The main feature of “Wanna Hang” is the creation of groups and events. Users can create a new group from scratch based on a topic and category. A specific location is mandatory, and a proper description and optional pictures will enrich the group information. A new community will start growing around that group, allowing the subscribers to organize real life events and occasions to meet. This will help people leave the virtual world inside their room and live interesting and focused experiences with real people sharing common interests and passions.

Groups and events can be “public” or “private”: public groups/events will be visible to all users, while private groups/events will be accessible only through a direct invitation. There must be a severe policy about group/event creation, to avoid sexual or offensive contents on the platform.

Use for Business Accounts

Business accounts will be created upon payment of a monthly/yearly fee. The first month could be either a trial period (to make the company try the service and see how the platform works) or a period with increased visibility on the platform (promoting the company's groups/events as featured contents on the platform).

Every company must create its own profile, with name, contacts and location as mandatory values. The next step is to create a new event or service that will take place in the company's location, by providing a category, some keywords and any interesting info to properly describe it. The event can also promote some products for sale, possibly with some discount to make the sale more appealing. For example, a winter wear store could create an event around Christmas, and promote winter clothes to be purchased. A notification about the upcoming event will be sent to all the users that live around the event's location and have the event's category/keywords among their interests. The users will see the event details, the other users that have already subscribed the event, and also the list of products that will be sold during the event. All products' prices must be correctly defined before the event is published, because no further changes will be allowed.

“Wanna Hang” offers a very good marketing opportunity to small companies that don't have a huge online visibility. All the promoted products will be shown to a targeted audience. Only the users that will match the event's category and keywords will see the products, so it's a very efficient channel to increase the sale or get new customers.

Check-In and Feedback

Every user that will participate in the event will be asked to perform a check-in through the app itself, scanning a QR code assigned to the event, in order to get a confirmation about the presence. The GPS accuracy will confirm that the user has really reached the event's location.

The check-in is important for both the company and the user. The more presences will be gathered, the more successful the event will be, thus increasing the company's global ranking in the platform. The user will increase his/her score on the platform and gain access to discounts and special offers by the company itself.

Each event/activity can have one or more users working as “promoters”, that will have a full access to the event's organization and will report negative feedback about participants.

Positive Feedback to Businesses/Events:
will increase the visibility on search results

Positive Feedback to Users:
will increase the user's score on the platform

Negative Feedback to Businesses/Events and Users:
will be always verified by the Wanna Hang team
if a specified threshold is exceeded, the business/user will be blocked

The participants can take pictures and tag friends and promoters, and create photo albums to be shared on the platform. It is not permitted to use the app for any illegal purposes, like fraud and money laundering, unlawful sexually oriented materials or services, unlawful gambling activities, etc.

Monetization

As explained above, “Wanna Hang” can make small businesses get into a larger market, helping them reach new customers and find new channels to sell their products. There is also an interesting opportunity to monetize the app and make a good business out of it.

First of all, the app should be free for standard users, the ones that just want to subscribe groups and participate in events/activities. A subscription fee could be requested to businesses, as a monthly/yearly payment, for example. Another option could be a fee upon every event creation, with additional fees if selling products during the event. The fee upon event creation could be optionally applied also to individuals, but it could be avoided if we want to pursue the goal of facilitating contacts between people in real life.

For Businesses:
1 month free trial, then monthly/yearly subscription
fee upon each event creation
additional fee if products are sold during the event

For Individuals:
free registration
fee upon event creation (optional)

Feature List for Individuals
Free registration
Select favorite area
Choose interests and passions from a list
View/edit personal profile
Create events/activities by category
Add pictures and keywords on event creation
Add friends from “Wanna Hang” or social networks
Join an event
Add new event reminders
Invite friends to the event
Check-in when attending the event
Share pictures of the event
Tag other event participants
Send feedback about the event
View/buy sponsored products
View own Wanna Hang level/score
Ask for support to the Wanna Hang team

Feature List for Businesses
Trial period on registration
Monthly/Yearly subscription fee
View/edit company profile
Create events/activities by category
Add pictures and keywords on event creation
Choose products to promote and sell during the event (own products/cross-selling)
Invite users to the event
View event participants through GPS check-in
Share pictures of the event
Tag event participants
Send feedback about the participants
View own Wanna Hang level/score
Ask for support to the Wanna Hang team

Feature List for Wanna Hang Team (Platform Administrators)
View/manage registered users (individuals/businesses)
View/manage events/activities
Content moderation on profiles/events/pictures/products/feedback
Accept/reject negative feedback
Block users/businesses that collected too many negative reviews
Promote users in the app (new registered individuals/businesses that need initial visibility)
Manage support requests (customer care)

1. “Wanna Hang” is a social network comprising:
a website
a mobile application
aiming to improve real life relationships, giving businesses tools to manage their own profile, create events for individual users, cross-sell products and view reports/statistics.

2. The mobile app will be the mean for individual users to manage their personal profile, find new friends around their area, create/join events and improve their real life relationships.

3. The platform will offer marketing opportunities to businesses, creating networks and connections between non-competitive companies, and increasing sales through events and initiatives.
